(19) United States
(12) Patent Application Publication
(10) Pub. No.: US 2023/0278455 A1
(43) Pub. Date: Sep. 7, 2023

(54) BATTERY EXCHANGE STATION FOR ELECTRIC VEHICLE SYSTEM AND METHODS

(71) Applicant: Electric Last Mile, Inc., Wilmington, DE (US)

(72) Inventors: NATHAN SALIGA, Clarkston, MI (US); JACQUELINE SIEGEL, ROYAL OAK, MI (US)

(73) Assignee: Electric Last Mile, Inc., Debtor, c/o David W. Carickhoff, Chapter 7 Trustee, Wilmington, DE (US)

(21) Appl. No.: 17/992,038

(22) Filed: Nov. 22, 2022

Related U.S. Application Data
(60) Provisional application No. 63/282,404, filed on Nov. 23, 2021.

(51) Int. Cl. B60L 53/80; B60S 5/06; B60L 53/66; B60L 53/65; B60L 53/51; B60L 53/16; H01M 10/613; H01M 10/625

(52) U.S. Cl. CPC B60L 53/80; B60S 5/06; B60L 53/66; B60L 53/65; B60L 53/51; B60L 53/16; H01M 10/613; H01M 10/625; H01M 2220/20

(57) ABSTRACT

A mobile battery charging and swap system includes a housing defining an opening configured to allow a vehicle travel through the housing via the opening and further, a power supply configured to supply electricity within the housing, a battery exchange system configured to selectively couple to a battery of a vehicle in response to the vehicle entering the housing and transport the battery to one of a plurality of receptacles, and a plurality of charging connectors configured to receive the electricity from the power supply and individually provide the electricity to a plurality of batteries including the battery.

### CROSS REFERENCE TO RELATED APPLICATION

This application claims the benefit of U.S. Provisional Application No. 63/282,404 filed on Nov. 23, 2021.

### BACKGROUND

The present disclosure relates generally to electric vehicles. More specifically, the present disclosure relates to systems and methods of charging an energy storage device included in an electric vehicle.

### BRIEF DESCRIPTION OF THE DRAWINGS

FIG. 1 is a perspective side view of an electric vehicle, according to an exemplary embodiment.

FIG. 2 is a bottom view of the electric vehicle of FIG. 1.

FIG. 3 is a perspective view of a battery charging and exchange system, according to an exemplary embodiment.

FIG. 4 is another perspective view of a battery charging and exchange system of FIG. 3.

FIG. 5 is a perspective view of a battery storage system included in the battery charging and exchange system of FIG. 3.

FIG. 6 is a perspective view of a battery exchange system included in the battery charging and exchange system of FIG. 3.

FIG. 7 is a schematic view of the battery charging and exchange system of FIG. 3.

FIG. 8 is a cross sectional view of an attachment system included in the electrical vehicle if FIG. 1.

FIG. 9 is a side view of the attachment system of FIG. 8.

FIG. 10 is a top view of the attachment system of FIG. 8.

FIG. 11 is a schematic view of a control system of the battery charging and exchange system of FIG. 3.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, an electric vehicle or hybrid-electric vehicle, collectively referred to as electric vehicles, include an electric battery that provides electricity (e.g., energy, power, etc.) to an electric motor to cause rotation of the wheels of the electric vehicle. In some electric vehicles, the battery is permanently or semi-permanently coupled to the electric vehicle. For example, the vehicle body may include a charging port configured to receive power from an external power supply. The charging port may be electrically coupled to the battery such that the battery can be charged using the external power supply. However, in this embodiment, the battery is not removed from the vehicle to charge the battery. While the battery may be removed to replace a faulty battery, the battery removal process is time consuming and labor intensive.

In the example provided above, the electric vehicle may have limited range as a result of the battery capacity. Further, when the battery is being charged, the electric vehicle may not be drivable. For example, many charging stations require the electric vehicle to remain in a single location while the vehicle is charging. Therefore, the need to charge the electric vehicle may result in significant down time. This may be especially problematic in situations where the electric vehicle is shared among several users (e.g., the electric vehicle is a member of a fleet of delivery vehicles).

According to various embodiments described herein, a battery charging and swap station and an electric vehicle are disclosed. The electric vehicle is configured to enter the battery charging and swap station and exchange a depleted battery for another battery that has a higher charge level. The battery charging and swap station may then charge the depleted battery such that it may be subsequently used by the electric vehicle or another electric vehicle. In this sense, the vehicle does not need to remain stationary as the battery charges, but instead can exchange a depleted battery for a fully charged battery or a battery with sufficient charge to provide enough energy for a desired range, thereby reducing electric vehicle downtime. Further, several battery charging and swap stations may be positioned about a desired drivable area such that the electric vehicle can exchange the depleted battery at various locations, thereby extending the range of the electric vehicle.

According to various embodiments, a fleet of vehicles may utilize the battery charging and swap station such that the batteries are cycled through a plurality of electric vehicles. For example, a fleet of delivery electric vehicles may utilize a plurality of battery charging and swap stations positioned about the delivery routes. Additionally, individual drivers may utilize the plurality battery charging and swap stations. For example, individuals may purchase a subscription to the plurality of battery charging and swap stations and exchange batteries on their own personal vehicle whenever desired. In this example, the initial cost of the electrical vehicles may be reduced as the electric vehicle need not includes a battery as a part of the purchase.

Further, by providing battery charging and swap stations, less expensive batteries can be used in conjunction with the electric vehicles as each battery may have a smaller capacity due to the ease of exchanging depleted batteries. For example, in electric vehicles with permanently fixed batteries, the batteries may need a high enough charge capacity for a user to travel to and from a desired location. Conversely, electric vehicles that utilize battery charging and swap stations only need a battery with enough capacity to get from one battery charging and swap station to another battery charging and swap station, where the depleted battery may be exchanged.

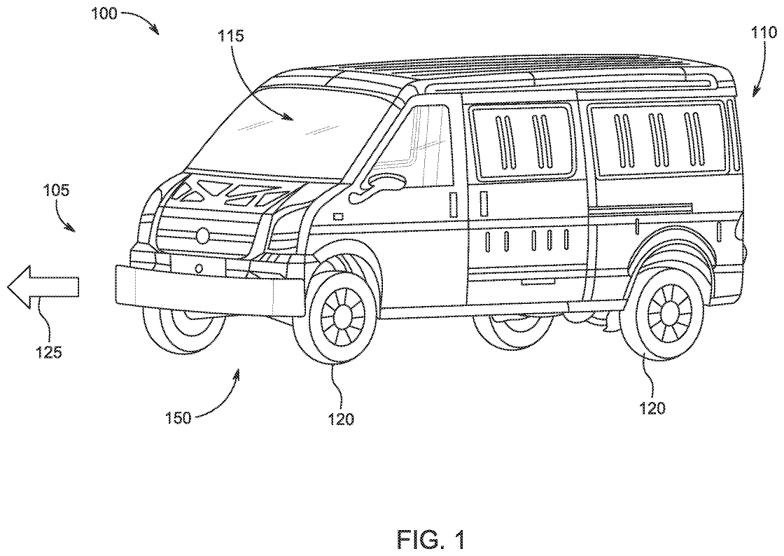

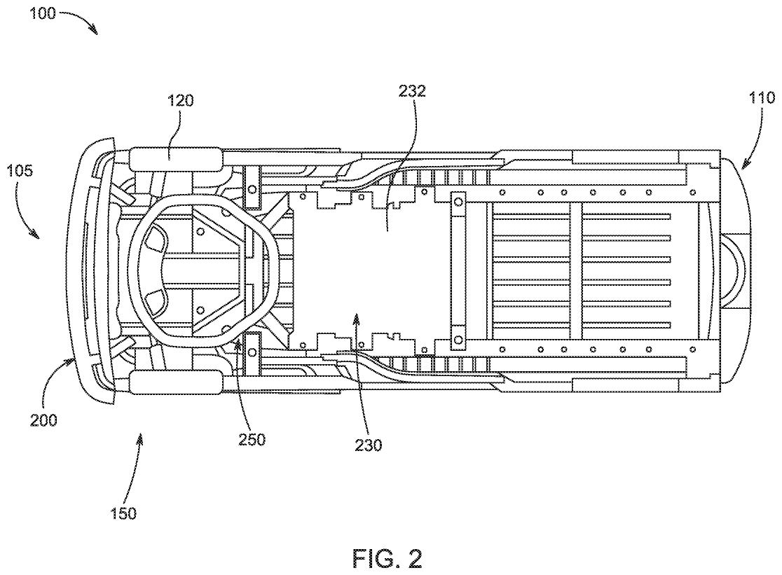

As shown in FIGS. 1 and 2, an electric vehicle 100 includes a front end 105 and a rear end 110 such that, in a normal operating position, the front end 105 is at the front of a forward direction of travel, as shown in arrow 125. The electric vehicle 100 includes an operating cabin 115, shown as cabin 115. Generally, the operating cabin 115 can be enclosed by a body of the electric vehicle 100. For example, the body of the electric vehicle 100 includes a frame and a plurality of wheels 120 coupled to the frame for movably supporting the electric vehicle 100 relative to a plane (e.g., road, ground, etc.). By way of example, the operating cabin 115 includes one or more seats for a user to operate the electric vehicle 100. According to another example, the electric vehicle 100 may be operated autonomously or semi-autonomously (e.g., vehicle includes a sensor for automatic steering, etc.). The electric vehicle 100 includes two front wheels 120 and two rear wheels 120, as shown in FIG. 1. The electric vehicle 100 includes an electric battery assembly 230, shown as assembly 230. For example, the electric battery assembly 230 includes an electric battery 232 (e.g., a battery pack) and several components to couple the electric battery with the electric vehicle 100, as will be discussed further herein. Generally, the electric vehicle 100 can operate by receiving a charge to the electric battery through one or more means including, but not limited to, an aerial vehicle charging system, an emergency charging system, and a highway charging system. In one embodiment, the electric battery assembly 230 can be positioned on an underside of the electric vehicle, as shown in FIG. 2. In one embodiment, the electric vehicle 100 is configured as an on-road vehicle such as a sedan, a sport utility vehicle (“SUV”), a pickup truck, a van, and/or still another type of passenger vehicle. In other embodiments, the electric vehicle 100 is configured as another type of on-road vehicle such as a semi-truck, a bus, or the like. In still other embodiments, the electric vehicle 100 is configured as an off-road vehicle such as construction machinery, farming machinery, or the like.

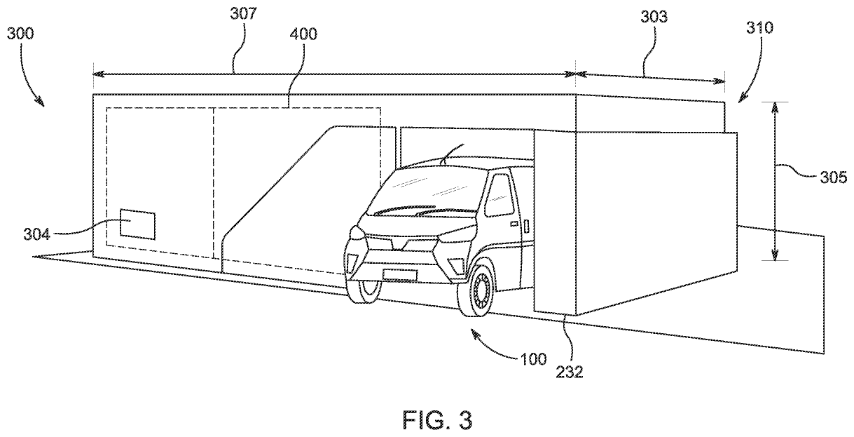

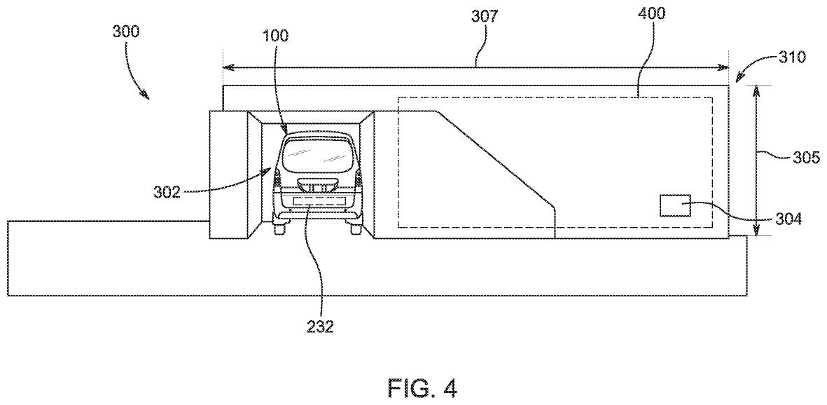

Referring now to FIGS. 3 and 4, a battery charging and swap station 300 is shown, according to an example embodiment. The battery charging and swap station 300 is configured to exchange a depleted battery 232 on an electric vehicle 100 with another battery 232 having a higher charge level. For example, the battery charging and swap station 300 may decouple the depleted battery 232 from the electric vehicle 100 via a battery exchange device (e.g., the battery exchange device 350 discussed below), transport the depleted battery 232 to a battery storage system 400 within the battery charging and swap station 300, retrieve a charged battery from the battery storage system 400, and couple the charged battery 232 to the electric vehicle 100 via the battery exchange device 350. Further, the battery charging and swap station 300 is configured to charge the depleted battery 232 such that the battery may be used by another electric vehicle 100. For example, as shown, the battery charging and swap station 300 includes a power supply 304 which may provide energy to charge one or more batteries 232 stored within the battery charging and swap station 300. According to various embodiments, the power supply 304 may charge the battery 232 at a rate of 6.6 kWh and between 300-400 A. According to various embodiments, the power supply 304 includes a solar panel, gasoline generator, a hydrogen cell, a connection to the electrical grid, a battery, a capacitor, and/or any combination thereof. For example, the battery charging and exchange system 300 may include a solar panel on top of the structure. Further, the battery charging and exchange system 300 may be directly coupled to the electric grid. It should be appreciate that the battery charging and swap station 300 and the battery storage system 400 may each include their own power supply 304.

As shown, the battery charging and swap station 300 includes an opening 302 configured to allow an electric vehicle 100 pass through the battery charging and swap station 300. For example, the electric vehicle 100 may enter the battery charging and swap station 300, shut down within the battery charging and swap station 300, exchange the depleted battery 232, and exit the battery charging and swap station 300 via the opening 302. According to various embodiments, the battery exchange is partially of completely autonomous. For example, an the battery charging and swap station 300 may automatically exchange the battery 232, without human assistance, in response to the vehicle 100 entering the opening 302 of the battery charging and swap station 300, as is discussed further herein.

According to various embodiments, the battery charging and swap station 300 may be stored and transported within a housing 310 that is sized such that the battery charging and swap station 300 may be easily transported. For example, the housing 310 may be the same size as a standard shipping container (e.g., 20 foot storage container, 40 foot storage container, an extra tall shipping container, etc.) such that the housing 310 may be loaded onto a truck and easily transported. Alternatively, the housing 310 may be sized to fit within a standard shipping container, such that it may be loaded into the shipping container and transported. For example, according to various embodiments, the housing 310 has a width 303 that is less than or equal to eight feet, a height 305 that less than or equal to nine feet, six inches, and a length 307 that is less than or equal to twenty feet. Alternatively, the length 307 may be less than or equal to forty feet.

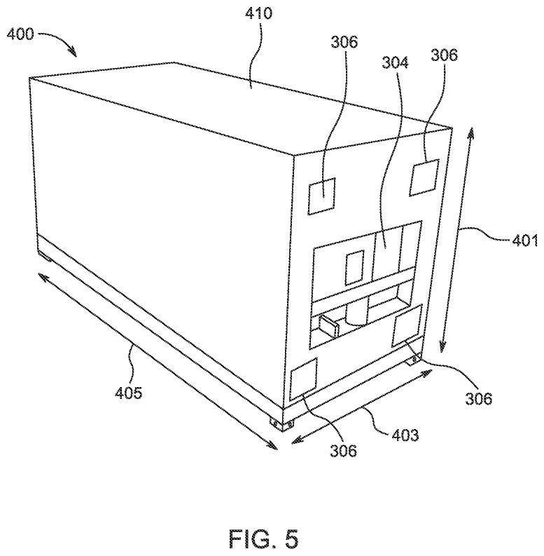

Referring now to FIG. 5, a battery storage system 400 is shown according to an example embodiment. As discussed above, the battery charging and swap station 300 includes a battery storage system 400. The battery storage system 400 is configured to receive a plurality of batteries 232, charge the plurality of batteries 232, and provide charged batteries 232 to the battery exchange device 350 such that the charged battery 232 may be coupled to and used by an electric vehicle 100.

According to various embodiments, the battery storage system 400 is removabley coupled to the remainder of the battery charging and swap station 300, such that the battery storage system 400 is portable. For example, the battery storage system 400 may include one or more coupling features 306 (e.g., latches, grooves, etc.) that allow the battery storage system 400 to be removed from the battery charging and swap station 300. In this sense, the battery storage system 400 may be exchanged with another battery storage system 400. For example, if a battery charging and swap station 300 has a relatively high number of battery exchanges or is running low on charged batteries 232, another battery storage system 400 having more charged batteries 232 may be exchanged with the current battery storage system 400. Further, if the battery storage system 400 needs repair or maintenance, the battery storage system 400 may be replaced without having to shut down the battery charging and swap station 300 while the repair or maintenance is performed.

According to various embodiments, the battery storage system 400 is stored within a housing 410 that is sized such that the battery storage system 400 may be easily transported. For example, the housing 410 may be the same size as a standard shipping container (e.g., 20 foot storage container, 40 foot storage container, etc.) such that the housing 410 may be loaded onto a truck and easily transported. Alternatively, the housing 410 may be sized to fit within a standard shipping container, such that it may be loaded into the shipping container and transported. For example, according to various embodiments, the housing 410 has a width 403 that is less than or equal to eight feet, a height 401 that less than or equal to nine feet, six inches, and a length that is less than or equal to twenty feet. Alternatively, the length 405 may be less than or equal to forty feet.

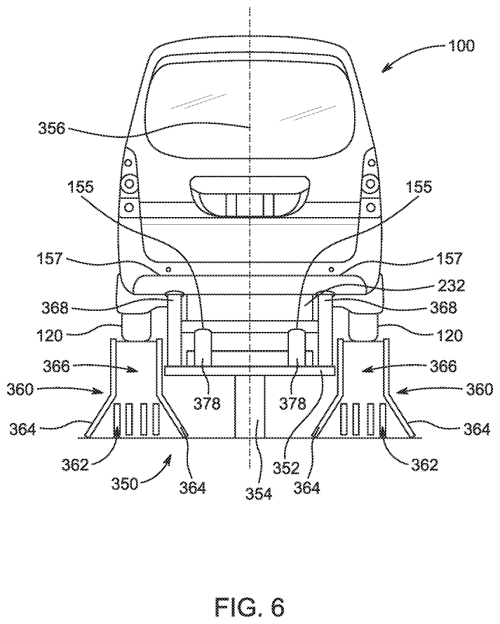

Referring now to FIG. 6, a battery exchange device 350 is shown according to an example embodiment. The battery exchange device 350 may be a part of the battery charging and swap station 300 shown above. The battery exchange device 350 is configured to remove a depleted battery 232 from an electric vehicle 100, provide the depleted battery 232 to a battery storage system 400, receive a charged battery 232 from the battery storage system 400, and couple the charged battery 232 to the electric vehicle 100.

As shown, the battery exchange device 350 includes a tire alignment track 360 for the left and right wheels 120 of the electric vehicle 100. The tire alignment tracks 360 are configured to center the electric vehicle 100 about the battery exchange device 350. As shown, the tire alignment tracks 360 include sidewalls 364 configured to contain the wheels 120 on the tire alignment tracks 360. As shown, the tire alignment tracks 360 include a tapered portion 362 proximate the entrance of the tire alignment tracks 360. The tapered portions 362, along with the sidewalls 364, provide a driver of the electric vehicle 100 with a wider entrance to the alignment track 360, thereby making it easier to move the electric vehicle 100 onto the alignment tracks 360. As shown, the alignment tracks 360 include an incline portion 366 such that the electric vehicle 100 will move upward along the vertical axis 356 as the electric vehicle 100 travels along the alignment tracks 360. As is discussed below, elevating the electric vehicle 100 will allow a platform 352 to raise up below the electric vehicle 100 to exchange batteries 232. However, according to various embodiments, the alignment tracks 360 may not include an incline portion 366 and the platform 352 may be otherwise submerged (e.g., installed below the ground) below the alignment tracks 360. While the example battery exchange device 350 is shown to include two alignment tracks 362, according to other embodiments, the battery exchange device 350 may only have one alignment track 362.

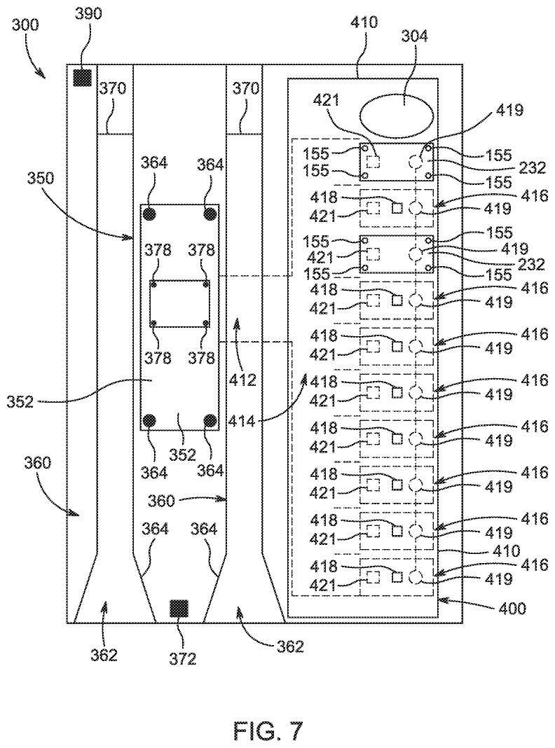

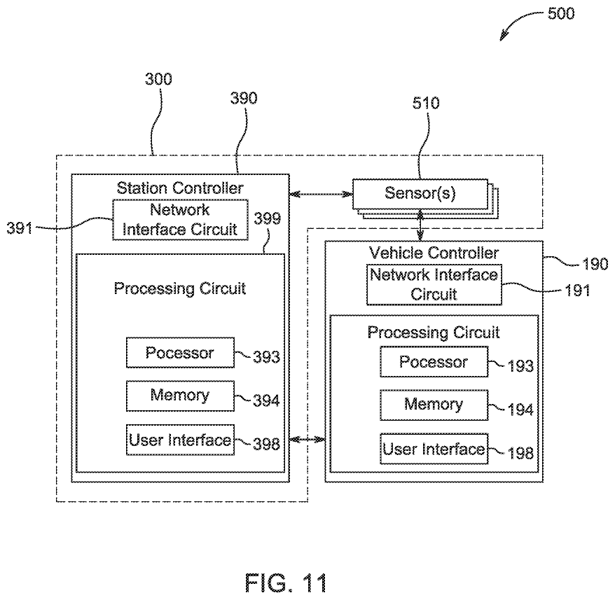

According to various embodiments, each alignment track 360 include a vehicle stop 370 (see FIG. 7). The vehicle stop 370 is configured to stop the electric vehicle 100 in a position such that the battery exchange device 350 can exchange the battery 232 of the electric vehicle. According to various embodiments, the vehicle stop 370 may include a physical feature, such as a bump or a rail, to provide feedback to the driver of the electrical vehicle 100. Additionally or alternatively, the vehicle stop 370 may include a vehicle sensor (e.g., a camera, a position sensor, a proximity sensor, a motion sensor, etc.) configured to detect the position of the electric vehicle 100. According to various embodiments, a controller 390 (see FIGS. 7 and 11) of the battery charging and swap station 300 may be in communication with a controller 190 of the vehicle (see FIG. 11) such that the battery charging and swap station 300 may cause the electric vehicle 100 to stop once the electric vehicle 100 reaches the vehicle stop 370 and/or causes the electric vehicle 100 to shut down once the electric vehicle 100 reaches the vehicle stop 370.

Further, the battery exchange device 350 includes a platform 352 coupled to a lifting mechanism 354. The lifting mechanism 354 is configured to move the platform 352 along a vertical axis 356 between a first position, a second position, and a third position, such that the platform 352 moves up and down relative to the electric vehicle 100. According to various embodiments, the third position is higher than the second position, which is higher than the first position.

The battery exchange device 350 further includes one or more alignment pins 368. The alignment pins 368 are configured to be individually received by alignment apertures 157. As shown, the alignment apertures 157 are located in the body of the electric vehicle 100. However, according to other embodiments, the alignment apertures 157 may be located within the battery 232 (e.g., the body of the battery 232). The alignment pins 368 are configured to be received by the alignment apertures 157 as the platform 352 translates in a vertical direction parallel to the vertical axis 356 from the first position to the second position.

According to various embodiment, the ends of the alignment pins 368 are conical and/or the openings of the alignment apertures 157 are tapered. As such, as the alignment pins 368 enter the alignment apertures 157, the alignment pin 368 will self-center within the alignment apertures 157 as a result of the conical ends of the alignment pins 368 and/or the tapered openings of the alignment apertures 157. According to various embodiments, the platform 352 is configured to passively translate in a horizontal plane that is perpendicular to the vertical axis 356 as the alignment pins 368 enter the alignment apertures 157 to further center the platform 352 under the battery 232. Further, according to various embodiments, the battery charging and swap station 300 may have one or more sensors configured to determine when the alignment pins 368 are positioned within the alignment apertures 157 and the battery charging and swap station 300 may cause the electric vehicle 100 to shut down in response to the alignment pins 368 being positioned within the alignment apertures 157 so that the battery 232 can be safely exchanged.

The battery exchange device 350 further includes one or more location pins 378. The location pins 378 are configured to be individually received by locations apertures 155. As shown, the location apertures 155 are located in the body of the battery 232. However, according to other embodiments, the location apertures 155 may be located within the body of the electric vehicle 100. The location pins 378 are configured to be received by the location apertures 155 as the platform 352 translates in a vertical direction parallel to the vertical axis 356 from the second position to the third position.

According to various embodiment, the ends of the location pins 378 are conical and/or the openings of the location apertures 155 are tapered. As such, as the location pins 378 enter the location apertures 155, the location pin 378 will self-center within the location aperture 155 as a result of the conical ends of the location pins 378 and/or the tapered openings of the location apertures 155. According to various embodiments, the platform 352 is configured to passively translate in a horizontal plane that is perpendicular to the vertical axis 356 as the location pins 378 enter the location apertures 155 to further center the platform 352 under the battery 232. Further, according to various embodiments, the battery charging and swap station may have one or more sensors configured to determine when the location pins 378 are positioned within the location apertures 155 and the battery charging and swap station 300 may cause the electric vehicle 100 to shut down in response to the location pins 378 being positioned within the location apertures 155 so that the battery 232 can be safely exchanged.

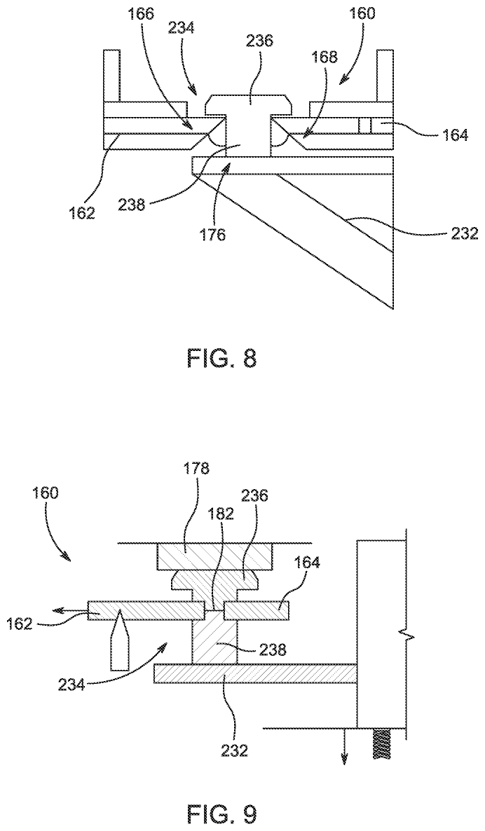

Once the platform is in the third position, the alignment pins 368 are received by alignment apertures 157, and the location pins 378 are received by the location apertures 155, the battery exchange device 350 may cause the battery 232 to be decoupled from the electric vehicle 100 such that the battery 232, as is described further below with respect to FIGS. 8-10. The battery exchange device 350 may then transport the battery 232 to the battery storage system 400 such that the battery 232 may be charged and stored for later use.

It should be appreciated that, while the example above describes removing a battery 232 from the electric vehicle 100, a similar process may be used to couple a charged batter 232 to the electric vehicle 100. For example, the alignment pins 368 may be received by alignment apertures 157, and the location pins 378 may be received by the location apertures 155 to center the charged battery 232 with respect to the electric vehicle 100 and couple the charged batter 232 to the electric vehicle.

Referring now to FIG. 7, a schematic view of the battery charging and swap station 300 is shown, according to an example embodiment. As shown, the battery charging and swap station 300 includes the battery exchange device 350 and the battery storage system 400.

As discussed above, the battery storage system 400 is configured to receive a plurality of batteries 232, charge the plurality of batteries 232, and provide charged batteries 232 to the battery exchange device 350 such that the charged battery 232 may be coupled to and used by an electric vehicle 100. For example, the battery exchange device 350 may transport a depleted battery 232 to a receiving bay 412 of the battery storage system 400. The battery storage system 400 may then transport the battery via a battery transportation device 414 (e.g., a conveyer belt) to one of the plurality of receptacles 416. Each of the receptacles 416 are positioned within the housing 410 and are configured to individually receive a plurality of batteries 232. As shown, the battery storage system 400 includes ten receptacles 416, however, according to other embodiments, the battery storage system 400 may include more.

Once a battery 232 is received by a receptacle 416, the battery 232 is coupled to a charging connector 418. Each charging connector 418 is configured to receive the energy from the power supply 304 and provide the energy to the respective battery 232 such that that charging connector 418 charges the battery 232. According to various embodiments, each of the receptacles 416 may include one or more sensors 421. For example, the charging connectors 418 may include charge sensors configured to determine a charge status of each of the plurality of batteries 232 coupled to the plurality of receptacles 416. Further, each of the plurality of charging connectors 418 may include a fault sensor configured to detect a fault in each of the plurality of batteries 232. Furthermore, each of the plurality of receptacles 416 may include a heat sensor, as discussed below.

According to various embodiments, each of the receptacles 416 includes a cooling device 419 (e.g., a heat exchanger, a fan, a cooling fluid circuit, etc.) as a part of a cooling loop included in the battery charging and exchange system 300. Each of the cooling devices 419 are configured to cool at least one of the plurality of batteries 232 (e.g., the battery 232 received by the respective receptacle 416) in response to at least one of the plurality of batteries 232 being received by one of the plurality of receptacles. The cooling loop may further include heat sensors (e.g., thermocouples, thermometers, etc.) configured to detect heat proximate the receptacles 416. In this sense, a feedback control loop me be used to keep each battery 232 within a predetermined temperature range.

According to various embodiments, the battery storage system 400 provides a charged battery 232 to the receiving bay 412. For example, after the depleted battery 232 is coupled to a receptacle 416, a charged battery 232 is provided to the receiving bay such that the battery exchange device 350 can install the battery 232. According to various embodiments, the charged battery 232 is fully charged. However, according to various embodiments, the charged battery 232 is only partially charged. For example, an operator of the electric vehicle 100 may indicate a desired range or travel route into a user interface (e.g., the user interface 198 discussed below with respect to FIG. 11). In response, the controller 390 may select a battery 232 with ample charge, as indicated by the charge sensor, to achieve the desired range or travel route. In this sense, the battery 232 selected by the battery charging and exchange system 300 is based on the charge status determined by the charge sensors.

According to various embodiments, the battery charging and swap station 300 further includes a vehicle identification sensor 372. The vehicle identification sensor 372 (e.g., a camera, a motion sensor, and RFID reader, a proximity sensor, etc.) is configured to identify an electric vehicle 100 entering or approaching the battery charging and swap station 300. Once identified, the controller 390 may reference the electric vehicle 100 identify against a predetermined list of electric vehicles 100 (e.g., vehicles that are subscribed to a battery swap service) to determine if the electric vehicle 100 is eligible to have its battery swapped. If the electric vehicle 100 is not eligible for a battery swap, the battery exchange system 350 may not remove or exchange the battery 232.

Referring now to FIGS. 8-10, an attachment system for the electric vehicle 100 is shown, according to an example embodiment. As shown, the battery 232 includes a first projection 234 extending from a surface of the battery 232. While FIGS. 8-10 only show a first projection 234, it should be appreciated that the battery 232 may include any number of projections similar to the first projection 234. The first projection includes a head 236 and a shaft 238. As shown, the head 236 is tapered and the shaft 238 is unthreaded. The battery 232 is configured to be received by a battery receptacle 160 that is coupled to the vehicle 100 such that the battery 232 can provide energy to the vehicle 100.

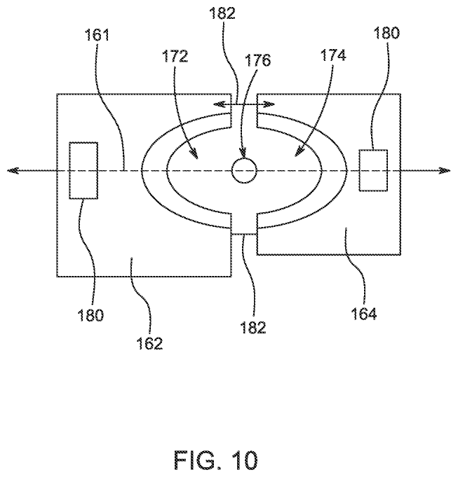

As shown, the battery receptacle 160 includes a first plate 162 and a second plate 164 configured to secure the battery 232 within the battery receptacle 160. According to various embodiments, the first plate 162 and the second plate 164 are configured to translate in a direction parallel to an axis 161 relative to one another. As shown in FIG. 10, the first plate 162 defines a first slot 172 and the second plate 164 includes a second slot 174. The first slot 172 and the second slot 174 collectively define an opening 176 configured to receive the first projection 234 of the battery 232. Further, the first plate 162 includes a first angled face 166 and the second plate 164 includes a second angled face 168 as shown in FIG. 8.

According to various embodiments, the first plate 162 and the second plate 164 are biased towards one another (e.g., via a spring). As described above with respect to FIG. 6, the platform 352 may raise a battery 232 towards the vehicle 100 to couple the battery 232 to the vehicle 100. As the first projection 234 approaches the first plate 162 and the second plate 164, the head 236 will interface with the angled faces 166, 168. The upward force from the platform 352 may be enough to overcome the biasing forces acting on the first plate 162 and the second plate 164 such that the opening 176 expands such that the head 236 is received within the battery receptacle 160. After the head 236 passes through the opening 176, the biasing forces may cause the first plate 162 and the second plate 164 to translate towards one another such that the opening 176 becomes smaller than the head 236 (e.g., as shown in FIG. 8), thereby securing the battery 232 to the vehicle 100. According to various embodiments, the attachment system further includes one or more locking pins 182 configured to couple the first plate 162 to the second plate 164 in response to the head 236 being received within the battery receptacle 160.

According to various embodiments, the battery receptacle 160 includes battery contact 178. The battery contact 178 is configured to transfer energy from the battery 232 to the vehicle 100. For example, when the head 234 is secured within the battery receptacle 160, the head 234 may contact the battery contact 178 to provide energy from the battery 232 to the vehicle 100.

According to various embodiments, the attachment system includes a release mechanism 180. The release mechanism 180 is configured to cause the opening 176 to expand such that the opening 176 is wider than the head 236 such that the battery 232 can be removed from the vehicle 100 (e.g., as described above with respect to FIG. 6). For example, when removing a depleted battery 232 from the vehicle 100, the battery exchange device 350 may active that release mechanism 180 such that the battery 232 may be decoupled from the vehicle 100. For example, the release mechanism 180 may be active in response to the location pin 378 is received within the location receptacle 155, the release mechanism 180 may be active, thereby releasing the battery 232.

Referring now to FIG. 11, a schematic view of a control system 500 for the battery charging and swap station 300 is shown according to an example embodiment. As shown, the control system includes the controller 390 discussed above, a plurality of sensors 510 (e.g., location sensors, cameras, position sensors, charge sensors, fault sensors, and any other type of sensor contemplated within this disclosure), and a vehicle controller 190. According to various embodiments, the controller 190, the sensors 510, and the vehicle controller 190 are all in communication with one another.

In various embodiments, the controller 390 is communicably coupled to sensor(s) 510, such that the data recorded by the sensor(s) 510 may be saved and analyzed. The controller 390 is also communicably coupled to vehicle controller 190 such that the controller 390 may control the electric vehicle 100 (e.g., by sending operating parameters to the electric vehicle 100).

As shown, the controller 390 includes a network interface circuit 391. The network interface circuit 391 is configured to enable the controller 390 to communicate via a network, such that information about the battery charging and exchange system 300 may be shared and information regarding electric vehicles 100 may be received. The network interface circuit 391 can include program logic that facilitates connection of the controller 390 to the network (e.g., a cellular network, Wi-Fi, Bluetooth, radio, etc.). The network interface circuit 391 can support communications between the controller 390 and other systems. For example, the network interface circuit 301 can include a cellular modem, a Bluetooth transceiver, a radio-frequency identification (RFID) transceiver, and a near-field communication (NFC) transmitter. In some embodiments, the network interface circuit 391 includes the hardware and machine-readable media sufficient to support communication over multiple channels of data communication. For example, the number of batteries 232, the charge of each of the batteries 232, and/or any other information about the battery charging and exchange system 300 may be shared with a plurality of electric vehicles 100. For example, an operator of an electric vehicle 100 may utilize a user interface 198 within the electric vehicle 100 to request a charged battery 232. In response, the controller 390 may provide a status of the batteries 232 located at the respective battery charging and exchange system 300.

The controller 390 further includes a processing circuit 399 and a user interface 398. The processing circuit 399 includes a processor 393 and a memory 394. The processor 393 may be coupled to the memory 394. The processor 393 may be a general purpose or specific purpose processor, an application specific integrated circuit (ASIC), one or more field programmable gate arrays (FPGAs), a group of processing components, or other suitable processing components. The processor 393 is configured to execute computer code or instructions stored in the memory 306 or received from other computer readable media (e.g., CDROM, network storage, a remote server, etc.).

The memory 394 may include one or more devices (e.g., memory units, memory devices, storage devices, etc.) for storing data and/or computer code for completing and/or facilitating the various processes described in the present disclosure. The memory 394 may include random access memory (RAM), read-only memory (ROM), hard drive storage, temporary storage, non-volatile memory, flash memory, optical memory, or any other suitable memory for storing software objects and/or computer instructions. The memory 394 may include database components, object code components, script components, or any other type of information structure for supporting the various activities and information structures described in the present disclosure. The memory 394 may be communicably connected to the processor 393 via processing circuit 399 and may include computer code for executing (e.g., by the processor 393) one or more of the processes described herein.

The user interface 398 is configured to present information to and receive information from a user. In some embodiments, user interface 398 includes a display device (e.g., a monitor, a touchscreen, hud, etc.). In some embodiments, user interface 398 includes an audio device (e.g., a microphone, a speaker, etc.). In various embodiments, user interface 398 receives alerts from the memory and presents the alerts to an operator the battery charging and swap system 300. For example, if a sensor 510 detects a fault in one of the batteries 232, the memory 394 may store this information and the user interface 398 may display this information. Further, the user interface 398 may display a charge status of each of the batteries 232.

As shown, the vehicle controller 190 includes a network interface circuit 191, a processing circuit 193, and a user interface 198. The vehicle controller 190 may be similar to the controller 390. For example, the vehicle controller 190 may communicate with the sensors 510 in a similar manner.

According to various embodiments, the user interface 198 may display information regarding a plurality of battery charging and swap stations 300. For example, the user interface may display the locations on a map, the number of batteries 232 available, and the charge statues of each of the batteries 232.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Language such as the phrases “at least one of X, Y, and Z” and “at least one of X, Y, or Z,” unless specifically stated otherwise, are understood to convey that an element may be either X; Y; Z; X and Y; X and Z; Y and Z; or X, Y, and Z (i.e., any combination of X, Y, and Z). Thus, such language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the electric vehicle 100 and components thereof (e.g., the energy-absorbing impact assembly 150, the wheels 120, etc.) as shown in the various exemplary embodiments is illustrative only. Additionally, any element disclosed in one embodiment may be incorporated or utilized with any other embodiment disclosed herein.

What is claimed is:

1. A battery charging and swap system, comprising:
a station defining an opening configured to allow a vehicle travel through the station via the opening, wherein the vehicle includes a battery;
a portable battery storage system removabley coupled to the station and configured to charge a plurality of batteries including the battery, the portable battery storage system including a housing configured to house the plurality of batteries;
a power supply configured to supply electricity within to the portable battery storage system;
a battery exchange device configured to selectively couple to a battery of a vehicle in response to the vehicle entering the housing and transport the battery to one of a plurality of receptacles, wherein
the portable battery storage system includes a plurality of charging connectors configured to receive the electricity from the power supply and individually provide the electricity to a plurality of batteries including the battery.

2. The battery charging and swap system of claim 1, wherein the battery is a first battery and the battery exchange system is further configured to selectively couple to a second battery coupled to one of the plurality of charging connectors and transport the battery to the vehicle such that the vehicle receives the electricity from the second battery.

3. The battery charging and swap system of claim 1, further comprising:
a vehicle sensor configured to detect the vehicle within the housing; and
a controller in communication with the vehicle sensor and configured to cause the vehicle to shut down in response to the vehicle entering the housing.

4. The battery charging and swap system of claim 3, wherein the vehicle sensor is further configured to identify the vehicle within the housing and the controller is configured to prevent the battery exchange system from coupling to the battery the vehicle in response to determining the vehicle does not match a predetermined list of vehicles.

5. The battery charging and swap system of claim 1, wherein the power supply includes at least one of a solar panel, gasoline generator, a hydrogen cell, and an electrical grid.

6. The battery charging and swap system of claim 1, further comprising a cooling loop configured to cool the battery in response to the battery being received by one of the plurality of receptacles.

7. The battery charging and swap system of claim 1, wherein the station is less than or equal to eight feet wide, less than or equal to nine feet, six inches high, and less than or equal to forty feet long.

8. The battery charging and swap system of claim 1, wherein the plurality of charging connectors includes at least ten individual charging connectors.

9. The battery charging and swap system of claim 1, further comprising a plurality of charge monitoring devices configured to determine a charge status of the plurality of batteries coupled to the plurality of charging connectors.

10. The battery charging and swap system of claim 1, further comprising a plurality of fault monitoring device configured to detect a fault in the battery.
